(19) United States
(12) Patent Application Publication
(10) Pub. No.: US 2019/0353348 A1
(43) Pub. Date: Nov. 21, 2019

(54) Ignitor For A Smoking Article

(71) Applicant: David Eugene Rundle, Umatilla, OR (US)

(72) Inventor: David Eugene Rundle, Umatilla, OR (US)

(21) Appl. No.: 15/984,327

(22) Filed: May 19, 2018

(51) Int. Cl. F23Q 7/16; F23Q 7/22; H05B 1/02

(52) U.S. Cl. CPC F23Q 7/16; H05B 1/0288; F23Q 7/22

(57) ABSTRACT

Embodiments are described for a ignitor for use with a smoking article such as a cigarette or pipe. The device has a heating element extending from a handle portion. A protective housing releasably engages with the handle portion and is dimensioned to receive the heating element therein. A power supply supplies voltage to the heating element to effectively ignite the smoking article.

### FIELD

The present invention generally relates to a heating element, and more specifically relates to a heating element for use with a smoking article.

### BACKGROUND

Cigarettes and similar smoking articles are a common part of everyday life throughout the world. In the current arts, smoking articles are typically lit using a match or flint lighter to ignite an open end of the smoking article while the user draws at an opposing open end. This in-turn ignites the smokable materials. Historically, matches have seen the most widespread adoption of use. While effective, they are prone to user error as well as degradation due to moisture or accidental destruction resulting in ineffective ignition. Modern flint lighters have been used since the early twentieth century and offer a more reliable source of flame for igniting smoking articles and other ignitable items.

Flint and similar lighters require a fuel source that is ignited via a spark. These lighters commonly contain butane, naphtha, or another volatile chemical that offers a sustained and controlled flame once ignited. While effective, burning of these chemicals can result in a myriad of biproducts that are carcinogenic and otherwise harmful to the user. While not extensively studied, it is believed that chronic inhalation of such biproducts may result in long-term side effects to the user.

In recent years, flameless lighters have become increasingly popular to mitigate health risks and provide an increase in efficacy during windy conditions. Many of these assemblies include a conductive wire or an artificial coal. Such lighters are commonly used in detention facilities, oil and gas facilities, nursing homes, airports, and other public areas. Flameless embodiments also exist as a component of a larger appliance such as within stoves and other appliances requiring ignition from a pilot flame.

It can be seen that further advancements surrounding the arts of flameless lighters is needed, especially those intended for use as a smoking article ignitor. One such advancement is described in various embodiment herein.

### SUMMARY OF THE INVENTION

Embodiments described herein provide for an ignitor for a smoking article such as a cigarette, cigar, pipe, or similar smoking article. The ignitor is comprised of a heating element extending from a handle portion. A protective housing covers the heating element to protect against unwanted contact between the heating element and a user or surface. The protective housing releasably engages from the handle portion such that the user may selectively engage and disengage the housing dependent on the present smoking article. A power supply is in operable communication with the heating element to supply voltage to the heating element, resulting in the heating thereof.

In an embodiment, the device has a microprocessor which controls the voltage delivered to the heating element. The user may determine the heat necessary to ignite the materials being consumed by the user. A memory may be in communication with the microprocessor to store settings related to specific users, smoking materials, or smoking articles among other useful settings and preferences.

In various aspects, the power source may be a 120V wall outlet. Other embodiments may include a plurality of batteries, rechargeable batteries, and USB-C inputs.

In another aspect of the present invention, the handle portion includes a display to visually transmit data to the user as well as show operations diagnostics and settings. A power switch, solid state switch, and at least one temperature controller may also be provided on the handle portion to permit the user to input various controls.

In an embodiment, the housing further comprises an aperture disposed along a length of the housing. The aperture is configured to receive a smoking article therethrough, such that the aperture guides the smoking article to sufficiently contact the heating element.

In a preferred embodiment, the heating element is a silicon nitride member. The member may be configured as an elongated cylindrical rod.

In yet another aspect, an annular ring is positioned between the heating element and the handle portion. The annular ring function as a means for deterring contact between the heating element, and a user or surface.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a front elevation view of the ignitor and smoking article, according to an embodiment of the present invention;

FIG. 2 illustrates an exploded view of the ignitor and housing, according to an embodiment of the present invention;

FIG. 3 illustrates a front elevation view of the ignitor in a battery-operated embodiment, according to an embodiment of the present invention;

FIG. 4 illustrates a perspective view of the ignitor and smoking article, according to an embodiment of the present invention; and

FIG. 5 illustrates a schematic diagram of the device, according to an embodiment of the present invention.

### DETAILED DESCRIPTION

The specific details of the single embodiment or variety of embodiments described herein are set forth in this application. Any specific details of the embodiments are used for demonstration purposes only and no unnecessary limitation or inferences are to be understood therefrom.

Any reference to “invention” within this document is a reference to an embodiment of a family of inventions, with no single embodiment including features that are necessarily included in all embodiments, unless otherwise stated. Furthermore, although there may be references to “advantage's” provided by some embodiments, other embodiments may not include those same advantages, or may include different advantages. Any advantages described herein are not to be construed as limiting to any of the claims.

Before describing in detail exemplary embodiments, it is noted that the embodiments reside primarily in combinations of components related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second and the like, may be used solely to distinguish one entity or element from another entity or element without necessarily requiring or implying any physical or logical relationship or order between such entities or elements.

Specific quantities, dimensions, spatial characteristics, compositional characteristics and performance characteristics may be used explicitly or implicitly herein, but such specific quantities are presented as examples only and are approximate values unless otherwise indicated. Discussions and depictions pertaining to these, if present, are presented as examples only and do not limit the applicability of other characteristics, unless otherwise indicated.

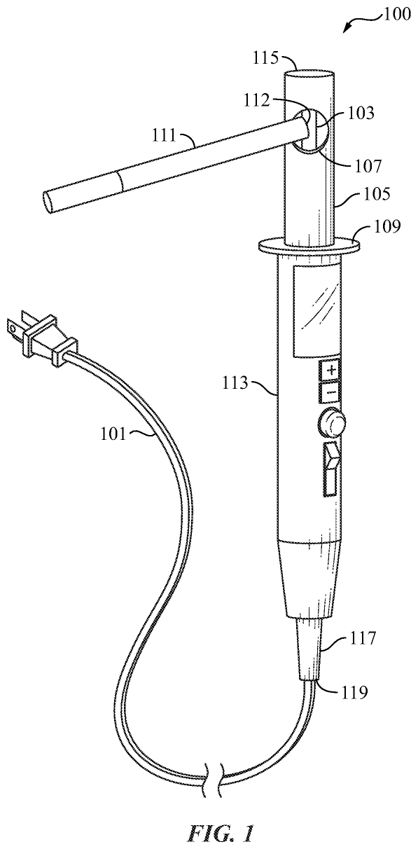

In general, and in reference to FIG. 1, the invention described herein relates to a device 100 having an ignitor to be used to ignite a smoking article. It can be understood that while a smoking article is the intended use of the invention, the invention may also be utilized to ignite other flammable articles. In the present embodiment, the power source is a 120V wall outlet requiring power supply means 101 to transfer power to the device. The power supply 101 is in electrical communication with and provides power to a heating element 103. In the present embodiment, the heating element 103 is a silicon nitride ignitor.

To promote safety and accidental contact of the heating element 103 during use, the device 100 may be provided with a removable housing 105 having an aperture 107. The removable housing 105 releasably engages a receiving portion 109 to retain the housing thereon. The aperture 107 permits the contact of a smoking article 111 to the heating element 103 while restricting accidental access of the users' body or other unwanted contact with the hot surface. In the instant embodiment wherein the smoking article 111 is a cigarette, the aperture 107 directs the cigarette to sufficiently contact the heating element at an ignition region 112 on the cigarette (typically the end of the cigarette). In the embodiment illustrated in FIG. 1, the aperture is dimensioned to selectively receive a cigarette, or similarly dimensioned smoking article.

In a preferred embodiment, the heating element 103 and housing 105 are positioned on a first end 115 of the device 100. The handle portion 113 extends between the heating element 103 and the second end 117 of the device. In the present embodiment, the power supply 101 enters an orifice 119 at the second end 117 to transmit power to the inner electrical components of the device 100.

While many shapes and configurations may exist, the heating element may be presented as an elongated cylindrical rod having a first end distal from the handle portion 113 of the device 100. The handle portion 113 preferably houses circuitry in electrical communication with the power supple 101 and power source (not shown). The handle portion 113 is preferably easily joined to the heating element 103 and housing 105 such as with snap-fit components, a friction fit, or a socket fit mechanism. The handle portion 113 and housing 105 are preferably constructed of a hard, heat-resistant material such as thermoresistant polymers, metals, or combinations thereof as commonly utilized in the arts. The device 100 is preferentially sized to fit comfortably in a hand of the user, however, one may appreciate that a number of sizes may be constructed for portability, or sedentary use.

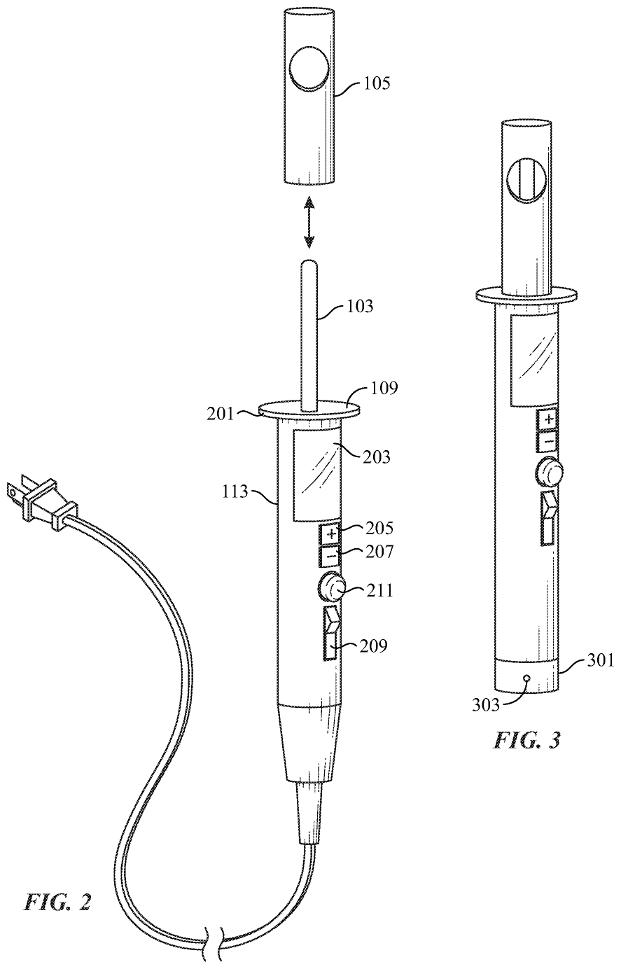

In reference to FIG. 2, the device 100 is illustrated having the protective housing 105 disengaged from the receiving portion 109. The receiving portion 109 may be provided as an annular ring 201 to protect the user from accidental contact with the heating element 103. The annular ring 201 is preferentially dimensioned to have a greater diameter than both the heating element 103 and the handle portion 113 such that the device 100 may lie down substantially horizontal on a surface while keeping the heating element from contacting the surface causing damage thereto.

The handle portion 113 may have a number of controls and visual aids thereon. In the illustrated embodiment, an electronic display 203, such as an LED screen is disposed on the surface of the handle portion 113. The display 203 may indicate ON/OFF of the device 100, settings, preferences, current or historical data of the device, among other features commonly utilized in the arts. Preferences may include heat settings dependent on user preference or as required by the particular smoking article. In one example, a memory may store ignition data of a multitude of smoking articles commonly associated with the device. Selecting a particular smoking article will change the power input and overall heat of the heating element 103 during use. In yet another embodiment, the memory may store preferred burn temperatures of particular smoking articles as set by the user. Heat output may be modulated by buttons 205, 207 permitting an increase and/or decrease in power supplied to the heating element 103.

In a preferred embodiment, an ON/OFF switch 209 controls the ON/OFF functionalities of the device as known in the arts. A solid state switch 211 controls the surge of power to and from the heating element when the device 100 is turned ON.

One skilled in the arts may appreciate that simpler, or even more complex controls may be presented on the device 100 offering more functionalities to the user. For example, a more economical embodiment may only provide simple ON/OFF functionality of the device 100 rather than advanced controls as illustrated herein.

The power source is sized to provide sufficient power for the heating element, in this case the heating element 103 to effectively ignite the smoking article 111. In alternate embodiments, the power source may be replaceable and/or rechargeable and include devices such as a capacitor, or a battery. In one example, the device 100 may utilize a plurality of batteries such as replaceable and rechargeable nickel cadmium battery cells connected in series with a total, non-loaded voltage of approximately 4.0 to 6.0 volts. The characteristics required of the power source will change dependent upon the characteristics of the various components within the device 100 as well as the burn temperature of the smoking article 111.

Silicon nitride is the preferred heating element due to its high melting-point characteristic while being relatively chemical inert at operating temperatures. One skilled in the arts may find that numerous materials may be utilized having similar properties. The materials used as the ignitor must be capable of repeated heating and cooling cycles without degradation or undesired reactions with surrounding chemicals encountered in the environment or via contact with the smoking article. Silicon nitride serves as an oxidation resistant insulating matrix with low density (3.20 g/cc). Resistivity of the heating element may be between 0.004-0.006 ohm-cm. The material should be fatigue resistant and oxidation resistant when subject to thermal cyclic pulsing and heating to 1000° C. repeatedly during the lifetime of the device.

In reference to FIG. 3, the second end 117 is adapted to be easily opened and closed, such as with screws or with snap-fit components, to facilitate replacement of the power source.

In an embodiment, the device 100 may have a phase controller including a signal conducting circuit, a microprocessor, and a memory. In operation, the microprocessor is connected to a thermostat and receives instructions to provide heat to the heating element. The microprocessor, which is in communication with the solid state switch, turns the solid state switch to ON and thus provides heat to the ignitor. This causes the heating element 103 to gradually warm to a target temperature as a result of increases resistance across the heating element 103. The user or manufacture may determine the warming period for the heating element to prevent the pulling down of the power supply voltage. In one example, the warming period may be three seconds. The warming period may be determined by the impedance vs. temperature curve of the selected heating element materials to prevent a loss of voltage and ill-effects to other articles connected to the power supply.

In an embodiment, member 301 covers an aperture extending into the interior cavity of the handle portion 113. The interior cavity houses circuitry required for the functionalities of the above-mentioned features and components. Input means 303 may be disposed on the member 301 to permit the input of a power supply permitting the power source to be recharged.

One skilled in the arts may appreciate that the power source may include 120V power sourced from a wall outlet, any number of batteries, USB-C power supplies, 12V power supplies, or any other power source known in the arts. One skilled in the arts will readily identify modifications to the circuitry needed to provide suitable function of the device 100.

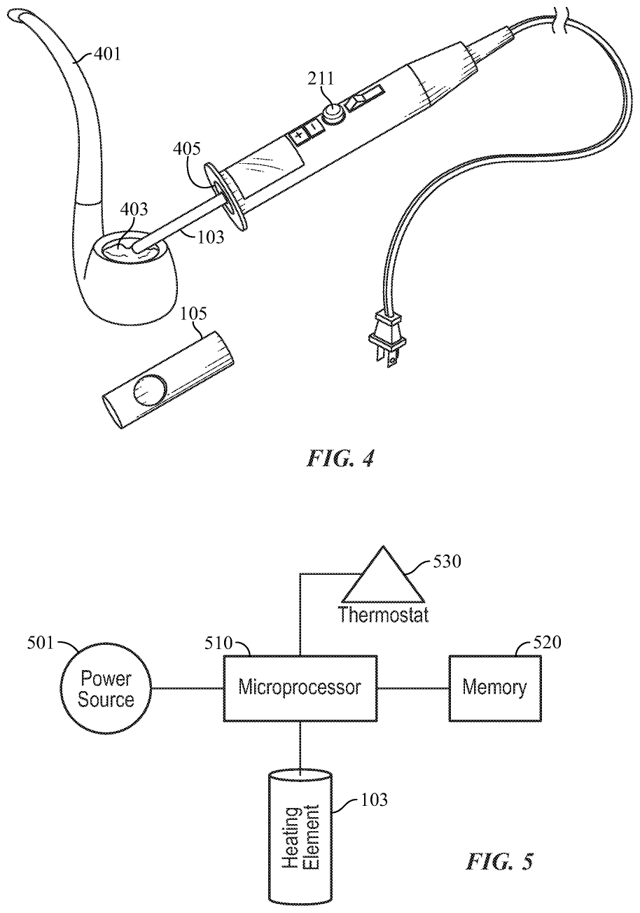

FIG. 4 illustrates the device having the protective housing 105 removed to reveal the heating element 103 therein. During use, the user first removes the protective housing 105. The solid state switch 211 is depressed to provide a power surge to the heating element 103. Once a suitable temperature has been reached, the user contacts the heating element 103 to the flammable material 403 disposed within the alternative smoking article 401. It can be seen that in comparison to FIG. 1 wherein a cigarette is illustrated, the alternative smoking article 401 requires the removal of the protective housing 105 for adequate contact with the smoking material 403.

In further reference to FIG. 4, a fixture 405 may securely engage the heating element 103 to the handle portion 113 while providing sufficient insulation to prohibit deformation or degradation of the handle portion 113 during use.

As new smoking article configuration are developed, one skilled in the arts may appreciate that simple modifications to the device 100 may be made to accommodate specific requirements of the smoking article. These modifications, such as orientation and shape of the heating element 103 may be performed without deterring from the present invention.

In reference to FIG. 5, power source 501 is connected to a microprocessor 510 in communication with a memory component 520. The microprocessor 510 controls the power input to the heating element 103. A thermostat 530 may be in communication with the microprocessor 510 to record temperature readings from the heating element 103.

In an embodiment, a phase controller may be utilized to limit the power used by the heating element to only that necessary for ignition of the flammable material. This temperate may change for each smoking article and material therein. For this reason, a means for temperature adjustment may be provided with the device 100. The phase controller also serves to extend the usable lifespan of the heating element 103.

In a further embodiment, the device 100 is configured to have a pressure sensor disposed thereon, such as within the housing 105. As the user draws from the smoking article, a drop in pressure is realized within the housing 105 thus resulting in a power surge across the heating element 103. In-turn, as the user draws on the smoking article, the heating element 103 will heat up and ignite the smoking article 111.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. An ignitor for a smoking article comprising:
a. a heating element extending from a handle portion;
b. a protective housing releasably engaged with the handle portion, wherein the protective housing is configured to cover the heating element;
c. a power supply in operable communication with the heating element, wherein the power supply is configured to supply voltage to the heating element.

2. The device of claim 1, further comprising a microprocessor, wherein the microprocessor controls the voltage supplied to the heating element.

3. The device of claim 2, further comprising a memory in operable communication with the microprocessor.

4. The device of claim 1, wherein the power supply is a 120 volt wall outlet in connection with the heating element.

5. The device of claim 1, wherein the power supply is a plurality of batteries.

6. The device of claim 5, wherein the power supply is rechargeable.

7. The device of claim 1, wherein the handle portion further comprises:
a. a power switch; and
b. a solid state switch.

8. The device of claim 7, wherein the handle portion further comprises:
a. at least one controller, wherein the at least one controller controls a temperature of the heating element; and
b. a display disposed on a surface of the handle portion.

9. The device of claim 1, wherein the housing further comprises an aperture disposed along a length of the housing, wherein the aperture is configured to receive a smoking article therethrough, wherein the aperture guides the smoking article to sufficiently contact the heating element.

10. The device of claim 1, wherein the heating element is a silicon nitride member.

11. The device of claim 10, wherein the silicon nitride member is an elongated cylindrical rod.

12. An ignitor for a smoking article comprising:
a. a heating element extending from a handle portion having a plurality operable controls thereon;
b. a protective housing releasably engaged with the handle portion, wherein the protective housing is configured to cover the heating element, the protective housing having an aperture disposed thereon, wherein the aperture is configured to receive a smoking article therethrough, wherein the aperture guides the smoking article to sufficiently contact the heating element; and
c. a power supply in operable communication with the heating element, wherein the power supply is configured to supply voltage to the heating element.

13. The device of claim 12, wherein the handle portion further comprises an annular ring, wherein the annular ring is configured to prohibit contact between the heating element and a surface.

14. The device of claim 12, wherein the operable controls are comprised of:
a. at least one temperature controller;
b. a power switch; and
c. a solid state switch.

15. The device of claim 14, wherein the handle portion further comprises a display.

16. The device of claim 12, wherein the housing is releasably engaged via snap-fit components.

17. The device of claim 16, wherein the housing is selectively removed by the user.

18. The device of claim 12, wherein the heating element is a silicon nitride member.

19. The device of claim 18, wherein the silicon nitride member is an elongated cylindrical rod.

20. The device of claim 19, wherein the silicon nitride member extends from a fixture disposed on an end of the handle portion, wherein the fixture effectively insulates the handle portion from the silicon nitride member.
